(19) United States
(12) Patent Application Publication
(10) Pub. No.: US 2004/0086442 A1
(43) Pub. Date: May 6, 2004

(54) Flue gas treatments to reduce NOx and CO emissions

(75) Inventor: Albert Vierheilig, Savannah, GA (US)

Correspondence Address: Kristin Joslyn, Hale and Dorr LLP, 300 Park Avenue, New York, NY, 10022, US

(73) Assignee: Intercat, Inc., Manasquan, NJ (US)

(21) Appl. No.: 10/639,688

(22) Filed: Aug. 13, 2003

Related U.S. Application Data
(60) Provisional application No. 60/402,710, filed on Aug. 13, 2002.

(51) Int. Cl. B01D 53/56

(52) U.S. Cl. 423/239.1

(57) ABSTRACT

The invention provides compositions and methods to reduce NOx emissions from the flue gas of a fluid catalytic cracking (FCC) unit. The invention also provides methods for reducing CO emissions from the regenerator and/or the flue of an FCC unit. The compositions of the invention comprise copper and/or cobalt and a carrier. The carrier can be, for example, hydrotalcite like compounds, spinels, alumina, zinc titanate, zinc aluminate, zinc titanate/zinc aluminate, and the like.

### RELATED APPLICATIONS

This application claims priority to U.S. Provisional Application No. 60/402,710 filed Aug. 13, 2002.

### FIELD OF THE INVENTION

The invention provides compositions and methods to reduce NOx and CO emissions from the flue gas of a fluid catalytic cracking (FCC) unit.

### BACKGROUND OF THE INVENTION

An exemplary regenerator and stack in an FCC unit is shown in FIG. 1. The coked catalyst is carried from the cracking vessel (not shown) of the FCC unit to the catalyst regenerator 2 via transfer conduit 4. The spent catalyst is regenerated in a fluidized bed 6 by burning the coke off the catalyst in the presence of air introduced into the regenerator 2 by means of air conduit 8. The regenerated catalyst is returned to the cracking vessel via transfer conduit 10. NOx (e.g., NO, NO₂, N₂O, N₂O₄, N₂O₅) and CO formed in the regenerator 2 pass out of the fluidized bed 6 and leave the regenerator with the flue gas via conduit 12. From the regenerator, the flue gas is carried via conduit 12 to a stack 36 where it is released into the atmosphere. The flue can optionally contain one or more components such as a quencher 14 (e.g., a flue gas cooler and the like), an electrostatic precipitator 15, a SOx scrubber 16, and the like. The optional components (e.g., 14, 15, 16) can be arranged in any order along the flue with respect to each other.

It is known in the art that NOx can be removed from the flue gas with NH₃, which is a selective reducing agent that does not react rapidly with excess oxygen that may be present in the flue gas. Two types of NH₃ processes have evolved, thermal and catalytic. Thermal processes operate as homogeneous gas-phase processes at high temperatures, typically around 1550 to 1900° F. The catalytic systems generally operate at much lower temperatures, typically at 300 to 850° F. U.S. Pat. No. 4,521,389 describes adding NH₃ to flue gas to catalytically reduce the NOx to nitrogen.

Flue gas treatments to reduce NOx are powerful, but the capital and operating costs are high. There is a need in the art for new methods of reducing NOx and other emissions from the flue gas of an FCC unit. The invention is directed to this, as well as other, important ends.

### SUMMARY OF THE INVENTION

The invention provides flue gas treatments for reducing NOx in the flue of an FCC unit by adding at least one composition comprising copper and/or cobalt to the regenerator of the FCC unit in an amount sufficient to reduce NOx in the flue of the FCC unit. In one embodiment of the invention, the amount of NOx emitted from the regenerator is the same as or greater than the amount of NOx emitted from the regenerator in the absence of the composition.

In another embodiment, the invention provides flue gas treatments for reducing NOx from the flue of an FCC unit by adding at least one composition comprising copper and/or cobalt to the regenerator of the FCC unit, where the regenerator has poor or uneven air distribution.

In another embodiment, the invention provides flue gas treatments for reducing CO from the flue of an FCC unit by adding at least one composition comprising copper and/or cobalt to the regenerator of the FCC unit in an amount sufficient to reduce CO in the flue of the FCC unit. In another embodiment, the invention provides methods for reducing CO from the regenerator of an FCC unit.

The compositions that are useful in the flue gas treatments and methods of the invention comprise copper and/or cobalt. The copper and cobalt can be in the form of their metals and/or their oxides. In other embodiments, the compositions comprise copper and/or cobalt and at least one carrier selected from hydrotalcite like compounds, spinels, alumina, silica, calcium aluminate, aluminum silicate, aluminum titanate, zinc titanate, zinc aluminate, zinc titanate/zinc aluminate, aluminum zirconate, magnesium aluminate, aluminum hydroxide, aluminum-containing metal oxide compounds other than Al₂O₃, clay, magnesia, lanthana, zirconia, titania, clay/phosphate materials, magnesium acetate, magnesium nitrate, magnesium chloride, magnesium hydroxide, magnesium carbonate, magnesium formate, hydrous magnesium silicate, magnesium silicate, magnesium calcium silicate, boria, calcium silicate, calcium oxide, aluminum nitrohydrate, aluminum chlorohydrate, silica/alumina, zeolites (e.g., ZSM-5), and mixtures of two or more thereof. Other carriers known in the art can also be used in conjunction with the copper and/or cobalt. In one embodiment, the carrier is a hydrotalcite like compound, a spinel, alumina, zinc titanate, zinc aluminate or zinc titanate/zinc aluminate.

These and other aspects of the invention are described in more detail below.

### BRIEF DESCRIPTION OF THE FIGURE

FIG. 1 shows an exemplary regenerator in an FCC unit, including the flue.

### DETAILED DESCRIPTION OF THE INVENTION

The invention provides compositions and methods for reducing NOx in the flue gas of an FCC unit. It has been unexpectedly discovered that NOx can be reduced in the flue gas of an FCC unit by adding one or more compositions comprising copper and/or cobalt to the regenerator in the FCC unit. In some embodiments of the invention, the compositions do not reduce, and may even increase, the NOx emitted from the regenerator, and then, unexpectedly, the NOx is reduced in the flue gas between the regenerator and the outlet of the stack.

The compositions and methods of the invention can be used in any conventional FCC unit. The FCC unit can have a full combustion regenerator, a partial combustion regenerator, or a dual combustion regenerator (e.g., a combustion regenerator having oxidizing and reducing environments). The compositions and methods are applicable to moving bed and fluidized bed catalytic cracking units.

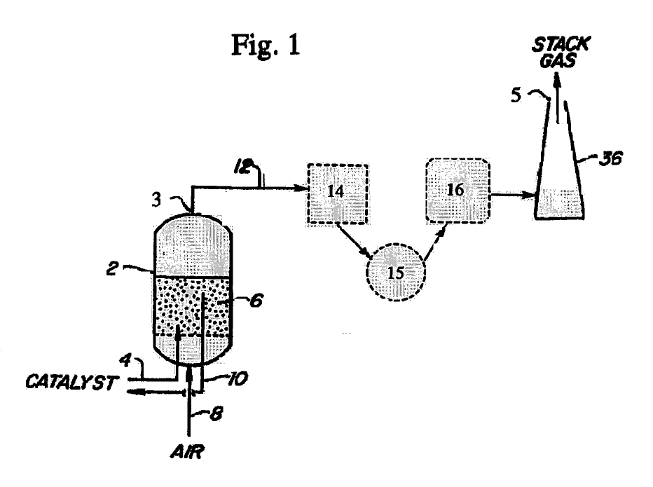

Air is continually introduced into the regenerator of the FCC unit. FIG. 1 shows the air being introduced into the bottom of the regenerator, although one skilled in the art will appreciate that air can be introduced at any location in the regenerator. Air contains about 21% oxygen (i.e., O₂), about 78% nitrogen (i.e., N₂), and about 1% of other components. The air may be evenly distributed throughout the regenerator or the air may be unevenly distributed in the regenerator. Generally, the air in the regenerator is unevenly distributed. Uneven distribution means that there are areas in the regenerator that have high oxygen concentrations (e.g., above 2% oxygen; above 3% oxygen; above 4% oxygen; or above 5% oxygen, i.e., an oxidizing environment) and areas that have low oxygen concentrations (e.g., less than 2% oxygen, i.e., a reducing environment). It has been discovered that the compositions of the invention reduce NOx emissions from the flue gas when the FCC unit has a regenerator that contains oxygen that is either evenly or unevenly distributed in the regenerator. In one embodiment, the compositions are added to a regenerator that has uneven oxygen distribution.

It has been unexpectedly discovered that when the compositions of the invention are used in the regenerator 2, the NOx emissions are reduced in the flue, i.e., between the point of emission from the regenerator 3 and the point of emission from the stack 5. The length of the flue (i.e., the length between 3 and 5 in FIG. 1) is generally at least about 25 feet, and can be about 200 feet or more. The flue can optionally contain quenchers, SOx scrubbers, electrostatic precipitators, and the like.

In one embodiment, the compositions of the invention comprise copper and a carrier, where the carrier is a hydrotalcite like compound, spinel, alumina (Al₂O₃), silica, calcium aluminate, aluminum silicate, aluminum titanate, zinc titanate, zinc aluminate, zinc titanate/zinc aluminate, aluminum zirconate, magnesium aluminate, aluminum hydroxide, an aluminum-containing metal oxide compound other than Al₂O₃, clay, magnesia, lanthana, zirconia, titania, a clay/phosphate material, magnesium acetate, magnesium nitrate, magnesium chloride, magnesium hydroxide, magnesium carbonate, magnesium formate, hydrous magnesium silicate, magnesium silicate, magnesium calcium silicate, boria, calcium silicate, calcium oxide, aluminum nitrohydrate, aluminum chlorohydrate, silica/alumina, zeolite, or a mixture of two or more thereof. The compositions of the invention can optionally further comprise cerium, preferably in the form of CeO₂. In one embodiment, the compositions of the invention comprise copper and a carrier, where the carrier is a hydrotalcite like compound, spinel, alumina (Al₂O₃), zinc titanate, zinc aluminate, or zinc titanate/zinc aluminate.

In another embodiment, the compositions of the invention comprise cobalt and a carrier, where the carrier is a hydrotalcite like compound, alumina (Al₂O₃), spinel, silica, calcium aluminate, aluminum silicate, aluminum titanate, zinc titanate, zinc aluminate, zinc titanate/zinc aluminate, aluminum zirconate, magnesium aluminate, aluminum hydroxide, an aluminum-containing metal oxide compound other than Al₂O₃, clay, magnesia, lanthana, zirconia, titania, a clay/phosphate material, magnesium acetate, magnesium nitrate, magnesium chloride, magnesium hydroxide, magnesium carbonate, magnesium formate, hydrous magnesium silicate, magnesium silicate, magnesium calcium silicate, boria, calcium silicate, calcium oxide, aluminum nitrohydrate, aluminum chlorohydrate, silica/alumina, zeolite, or a mixture of two or more thereof. The compositions of the invention can optionally further comprise cerium, preferably in the form of CeO₂. In one embodiment, the compositions of the invention comprise cobalt and a carrier, where the carrier is a hydrotalcite like compound, spinel, alumina (Al₂O₃), zinc titanate, zinc aluminate, or zinc titanate/zinc aluminate.

In another embodiment, the compositions of the invention comprise copper, cobalt and a carrier, where the carrier is a hydrotalcite like compound, alumina (Al₂O₃), spinel, silica, calcium aluminate, aluminum silicate, aluminum titanate, zinc titanate, zinc aluminate, zinc titanate/zinc aluminate, aluminum zirconate, magnesium aluminate, aluminum hydroxide, an aluminum-containing metal oxide compound other than Al₂O₃, clay, magnesia, lanthana, zirconia, titania, a clay/phosphate material, magnesium acetate, magnesium nitrate, magnesium chloride, magnesium hydroxide, magnesium carbonate, magnesium formate, hydrous magnesium silicate, magnesium silicate, magnesium calcium silicate, boria, calcium silicate, calcium oxide, aluminum nitrohydrate, aluminum chlorohydrate, silica/alumina, zeolite, or a mixture of two or more thereof. The compositions of the invention can optionally further comprise cerium, preferably in the form of CeO₂. In one embodiment, the compositions of the invention comprise copper, cobalt and a carrier, where the carrier is a hydrotalcite like compound, spinel, alumina (Al₂O₃), zinc titanate, zinc aluminate, or zinc titanate/zinc aluminate.

Methods for making the carriers are known in the art. The compositions of the invention can be made, for example, by impregnating dried forms of the carriers with solutions containing ions of copper and/or cobalt. One skilled in the art will appreciate that the copper and cobalt can be in the form of their metal and/or their oxide in the compositions of the invention.

In one embodiment, the compositions of the invention comprise copper and a hydrotalcite like compound, where the hydrotalcite like compound comprises Mg. In another embodiment, the compositions of the invention comprise copper and a hydrotalcite like compound, where the hydrotalcite like compound comprises Mg and Al. In another embodiment, the compositions of the invention comprise cobalt and a hydrotalcite like compound, where the hydrotalcite like compound comprises Mg. In another embodiment, the compositions of the invention comprise cobalt and a hydrotalcite like compound, where the hydrotalcite like compound comprises Mg and Al. In another embodiment, the compositions of the invention comprise copper, cobalt and a hydrotalcite like compound, where the hydrotalcite like compound comprises Mg. In another embodiment, the compositions of the invention comprise copper, cobalt and a hydrotalcite like compound, where the hydrotalcite like compound comprises Mg and Al. In the hydrotalcite like compound, the magnesium and aluminum are generally present in a ratio of about 1.5:1 to about 6:1; about 2:1 to about 5:1; about 2:1 to about 4:1; or about 3:1.

On a dry basis, the compositions of the invention comprise about 45 to about 65 weight % magnesium oxide (MgO), about 10 to about 30 weight % alumina (Al₂O₃), and about 5 to about 30 weight % copper oxide (CuO) and/or cobalt oxide (CoO). In another embodiment, the compositions of the invention comprise about 50 to about 60 weight % magnesium oxide (MgO), about 18 to about 28 weight % alumina (Al₂O₃), and about 15 to about 25 weight % copper oxide (CuO) and/or cobalt oxide (CoO). In another embodiment, the compositions of the invention comprise about 56 weight % magnesium oxide (MgO), about 24 weight % alumina (Al₂O₃), and about 20 weight % copper oxide (CuO) and/or cobalt oxide (CoO).

The dry basis compositions are hydrated to produce the final product comprising about 75 to about 95 weight % hydrotalcite like compound, about 3 to about 23 weight % CuO and/or CoO, and about 1 to about 5 weight % moisture at 110° C.; or about 80 to about 90 weight % hydrotalcite like compound, about 8 to about 18 weight % CuO and/or CoO, and about 1 to about 3 weight % moisture at 110° C.; or about 85 weight % hydrotalcite like compound, about 13 weight % CuO and/or CoO, and about 2 weight % moisture at 110° C.

When the compositions of the invention comprise CeO₂, the CeO₂ is present in an amount greater than 10% by weight; in an amount of about 11% to about 30%; in an amount of about 12% to about 25%; in an amount of about 13% to about 22%; in an amount of about 14% to about 20%; or in an amount of about 15% to about 20%.

In another embodiment, the compositions of the invention comprise copper and/or cobalt in combination with a hydrotalcite like compound having the chemical structure:

(Xₘ²⁺Yₙ³⁺(OH)₂ₘ₊₂ₙ)Z_{n/a}^{a-}•bH₂O

where X²⁺is Mg, Ca, Zn, Mn, Co, Ni, Sr, Ba, Fe or Cu; Y³⁺is Al, Mn, Fe, Co, Ni, Cr, Ga, B, La or Ce; m and n are integers selected such that the ratio of m/n is about 1 to about 10; a is 1, 2, or 3; b is an integer from 0 to 10; and Z is an anion with a charge of −1, −2 or −3 (e.g., CO₃, NO₃, SO₄, Cl, OH, Cr, I, SO₄, SiO₃, HPO₃, MnO₄, HGaO₃, HVO₄, ClO₄, BO₃, and the like). In one embodiment, Z is OH. In one embodiment, the hydrotalcite like compound is Mg₆Al₂(OH)₁₈•4.5H₂O.

In another embodiment, the compositions of the invention comprise copper and/or cobalt in combination with a hydrotalcite like compound having an XRD pattern which has 2 theta peak positions that reasonably resemble those found in ICDD card 35-965; ICDD Card No. 22-0700; ICDD Card No. 35-1275; or ICDD Card No. 35-0964. In one embodiment, the hydrotalcite like compound has an XRD pattern which has 2 theta peak positions that reasonably resemble those found in ICDD card 35-965.

Methods for making hydrotalcite like compounds are described, for example, in U.S. Pat. No. 6,028,023, the disclosure of which is incorporated by reference herein in its entirety.

In other embodiments, the invention provides compositions comprising copper and/or cobalt and an aluminum carrier. Exemplary aluminum carriers include alumina (Al₂O₃), calcium aluminate, aluminum silicate, aluminum titanate, aluminum zirconate, magnesium aluminate, aluminum hydroxide, silica/alumina, aluminum nitrohydrate, aluminum chlorohydrate, an aluminum-containing metal oxide compound other than Al₂O₃, or a mixture of two or more thereof. Alumina and aluminum-containing compounds are desirable copper carriers since aluminum has a high degree of porosity and will maintain a comparatively high surface area over the temperature range normally encountered in the FCC unit. Alumina can be used as a copper carrier in the form of a finely divided powder or of macrosize particles formed from a powder.

In other embodiments, the compositions of the invention comprise copper and/or cobalt and a spinel carrier, e.g., MgAl₂O₄.

In other embodiments, the compositions of the invention comprise copper and/or cobalt and a zinc carrier, e.g., zinc titanate, zinc aluminate, zinc titanate/zinc aluminate. Zinc carriers are described, for example, in WO 99/42201, the disclosure of which is incorporated by reference herein in its entirety.

To reduce the NOx from the flue gas, the compositions of the invention are introduced into the regenerator and are continuously cycled between the FCC reactor and the regenerator. The compositions of the invention can be used in an unexpectedly small amount to reduce NOx and CO emissions. For example, the compositions of the invention can be used in an amount of about 1 ppm to about 1000 ppm, from about 2 ppm to about 500 ppm; from about 50 ppm to about 250 ppm; or from about 100 ppm to about 200 ppm. Alternatively, the compositions of the invention can be used in an amount of about 0.001 weight % to about 5 weight % of the circulating inventory of the total catalyst in the FCC regenerator; in an amount of about 0.001 weight % to about 1 weight % of the circulating inventory of the total catalyst in the FCC regenerator; or from about 0.01 weight % to about 0.1 weight % of the circulating inventory of the total catalyst in the FCC regenerator. The compositions of the invention can reduce the NOx and/or CO emissions from an FCC unit in about two hours or less; about one hour or less; about thirty minutes or less; about fifteen minutes or less; or about 5 minutes or less.

In another embodiment, the compositions of the invention reduce CO emissions from the regenerator of the FCC unit and/or from the flue gas in the flue of the FCC unit. In one embodiment, the invention provides flue gas treatments for reducing CO in the flue of an FCC unit by adding a composition comprising copper and/or cobalt and a carrier to the regenerator of the FCC unit. In another embodiment, the invention provides methods for reducing CO emissions from the regenerator of the FCC unit by adding a composition comprising copper and/or cobalt and a carrier to the regenerator of the FCC unit. In yet another embodiment, the invention provides methods for reducing CO in the flue of an FCC unit and for reducing CO emissions from the regenerator of the FCC unit by adding a composition comprising copper and/or cobalt and a carrier to the regenerator of the FCC unit. The carrier can be a hydrotalcite like compound, a spinel, alumina, silica, calcium aluminate, aluminum silicate, aluminum titanate, zinc titanate, aluminum zirconate, magnesium aluminate, aluminum hydroxide, an aluminum-containing metal oxide compound other than Al₂O₃, clay, magnesia, lanthana, zirconia, titania, a clay/phosphate material, magnesium acetate, magnesium nitrate, magnesium chloride, magnesium hydroxide, magnesium carbonate, magnesium formate, hydrous magnesium silicate, magnesium silicate, magnesium calcium silicate, boria, calcium silicate, calcium oxide, aluminum nitrohydrate, aluminum chlorohydrate, silica/alumina, zeolites (e.g., ZSM-5),or a mixture of two or more thereof. In one embodiment, the carrier is a hydrotalcite like compound, a spinel, alumina, zinc titanate, zinc aluminate or zinc titanate/zinc aluminate.

In another embodiment, the compositions of the invention can be used in conjunction with a CO combustion promoter, such as a platinum and/or alumina CO combustion promoter. From 0.01 to 100 weight ppm Pt metal, based on the inventory of the regenerator, may be used with good results. Very good results can be obtained with as little as 0.1 to 10 weight ppm platinum present on the catalyst in the unit.

Any conventional FCC feed can be used in the FCC unit. The feeds may range from the typical, such as petroleum distillates or residual stocks, either virgin or partially refined, to the atypical, such as coal oils and shale oils. The feed frequently will contain recycled hydrocarbons, such as light and heavy cycle oils which have already been subjected to cracking. Preferred feeds are gas oils, vacuum gas oils, atmospheric resids, and vacuum resids. Any commercially available FCC catalyst may be used. The catalyst can be 100% amorphous, but preferably includes some zeolite in a porous refractory matrix such as silica-alumina, clay, or the like. The zeolite is usually about 5 to about 40 weight % of the catalyst, with the rest being matrix. Conventional zeolites such as Y zeolites, or aluminum deficient forms of these zeolites, such as dealuminized Y, ultrastable Y and ultrahydrophobic Y may be used. The zeolites may be stabilized with rare earths, for example, in an amount of about 0.1 to about 10 weight %.

Relatively high silica zeolite containing catalysts can be used in the invention. They withstand the high temperatures usually associated with complete combustion of CO to CO₂ within the FCC regenerator. Such catalysts include those containing about 10 to about 40% ultrastable Y or rare earth ultrastable Y.

The catalyst inventory may also contain one or more additives, either present as separate additive particles, or mixed in with each particle of the cracking catalyst. Additives can be added to enhance octane, such as medium pore size zeolites, e.g., ZSM-5 and other materials having a similar crystal structure. Additives which adsorb SOx may also be used.

Conventional riser cracking conditions may be used. Typical riser cracking reaction conditions include catalyst/oil ratios of about 0.5:1 to about 15:1 and a catalyst contact time of about 0.1 to about 50 seconds, and riser top temperatures of about 900 to about 1050° F. It is important to have good mixing of feed with catalyst in the base of the riser reactor, using conventional techniques such as adding large amounts of atomizing steam, use of multiple nozzles, use of atomizing nozzles and similar technology. The base of the riser may comprise a riser catalyst acceleration zone. It is preferred to have the riser reactor discharge into a closed cyclone system for rapid and efficient separation of cracked products from spent catalyst.

### EXAMPLE

The following example is for purposes of illustration only and is not intended to limit the scope of the appended claims.

An FCC unit having typical operating conditions was used in this experiment. For example, the FCC unit had a regenerator temperature of about 1350° F., a feed rate of about 90,000 barrels per day, a conversion rate of about 75%, an excess O₂ concentration at the exit of the regenerator/beginning of the flue of about 0.5%; an excess O₂ concentration at the stack (i.e., end of the flue) of about 1%; and the basic nitrogen content of the feed was about 300 ppm.

Referring to FIG. 1, NOx and CO emissions from the regenerator 2 of an FCC unit were measured as close as practical to the beginning of the flue 3 and at the end of the flue 5 prior to adding the composition of the invention to the FCC unit.

The composition of the invention was added to the regenerator of the FCC unit in an amount of about 0.04 weight % of the circulating inventory of the total catalyst in the FCC regenerator. The composition contained 55.9 weight % magnesium oxide (MgO), 23.6 weight % alumina (Al₂O₃), and 20.6 weight % copper oxide (CuO) on a dry basis. The dry basis composition was hydrated to produce a composition comprising 85.0 weight % hydrotalcite like compound, 13.1 weight % CuO, and 1.9 weight % moisture @ 110° C.

Two hours after the composition of the invention was added to the regenerator of the FCC unit, the NOx and CO emissions were measured as close as practical to the beginning of the flue 3 and at the end of the flue 5. The results are shown in the Table below.

| | Δ NOx | Δ CO |
|---|---|---|
| Measurement taken at the exit of the regenerator | +5 ppm | −60 ppm |
| of the FCC unit | | |
| Measurement taken at the end of the Stack | −21 ppm | −42 ppm |

The results demonstrate that the composition of the invention reduced NOx emissions from the flue of an FCC unit, and reduced CO emissions from the regenerator and the flue of an FCC unit. The results further show that the NOx increased slightly near the regenerator exit and then decreased at the exit of the flue.

The patents, patent applications, and publications cited herein are incorporated by reference herein in their entirety.

Various modifications of the invention, in addition to those described herein, will be apparent to one skilled in the art from the foregoing description. Such modifications are intended to fall within the scope of the appended claims.

what is claimed is:

1. A flue gas treatment for reducing NOx in the flue of an FCC unit comprising adding a composition comprising at least one of copper and cobalt to the regenerator of the FCC unit in an amount sufficient to reduce NOx in the flue of the FCC unit.

2. The flue gas treatment of claim 1, comprising adding the composition to the regenerator of the FCC unit in an amount of about 0.001 weight % to about 5 weight % of the circulating inventory of the total catalyst in the FCC regenerator.

3. The flue gas treatment of claim 1, wherein the amount of NOx emitted from the regenerator is the same as or greater than the amount of NOx emitted from the regenerator in the absence of the composition.

4. The flue gas treatment of claim 1, wherein the composition comprises copper and a carrier selected from a hydrotalcite like compound, a spinel, alumina, zinc titanate, zinc aluminate and zinc titanate/zinc aluminate.

5. The flue gas treatment of claim 1, wherein the composition comprises at least one of copper oxide and cobalt oxide and a carrier selected from a hydrotalcite like compound, a spinel, alumina, zinc titanate, zinc aluminate and zinc titanate/zinc aluminate.

6. A flue gas treatment for reducing NOx in the flue of an FCC unit comprising adding a composition comprising copper and a hydrotalcite like compound to the regenerator of the FCC unit in an amount sufficient to reduce NOx in the flue of the FCC unit.

7. The flue gas treatment of claim 6, comprising adding the composition to the regenerator of the FCC unit in an amount of about 0.001 weight % to about 5 weight % of the circulating inventory of the total catalyst in the FCC regenerator.

8. The flue gas treatment of claim 6, wherein the amount of NOx emitted from the regenerator is the same as or greater than the amount of NOx emitted from the regenerator in the absence of the composition.

9. The flue gas treatment of claim 5, wherein the hydrotalcite like compound comprises magnesium and aluminum in a ratio of about 1.5:1 to about 6:1.

10. The flue gas treatment of claim 5, wherein the hydrotalcite like compound comprises magnesium and aluminum in a ratio of about 2:1 to about 5:1.

11. A flue gas treatment for reducing NOx in the flue of an FCC unit comprising adding a composition to the regenerator of the FCC unit, wherein the regenerator has uneven air distribution, and wherein the composition comprises at least one oxide selected from the group consisting of copper and cobalt and a carrier selected from the group consisting of a hydrotalcite like compound, a spinel, alumina, zinc titanate, zinc aluminate and zinc titanate/zinc aluminate.

12. The flue gas treatment of claim 11, wherein the regenerator has one or more areas with an oxygen concentration greater than 2% and one or more areas with an oxygen concentration less than 2%.

13. The flue gas treatment of claim 11, comprising adding the composition to the regenerator of the FCC unit in an amount of about 0.001 weight % to about 1 weight % of the circulating inventory of the total catalyst in the FCC regenerator.

14. The flue gas treatment of claim 11, further comprising reducing NOx in the regenerator of the FCC unit.

15. The flue gas treatment of claim 11, wherein the composition comprises about 3 to about 23 weight % CuO and about 75 to about 95 weight % of a hydrotalcite like compound comprising Mg and Al.

16. The flue gas treatment of claim 15, wherein the composition comprises about 45 to about 65 weight % MgO, about 10 to about 30 weight % Al₂O₃ and about 10 to about 30 weight % CuO, on a dry basis.

17. The flue gas treatment of claim 11, wherein the composition comprises about 3 to about 23 weight % CoO and about 75 to about 95 weight % of a hydrotalcite like compound comprising Mg and Al.

18. The flue gas treatment of claim 11, wherein the composition comprises about 45 to about 65 weight % MgO, about 10 to about 30 weight % Al₂O₃ and about 10 to about 30 weight % CoO, on a dry basis.

19. The flue gas treatment of claim 11, wherein the composition comprises about 3 to about 23 weight % CuO and CoO and about 75 to about 95 weight % of a hydrotalcite like compound comprising Mg and Al.

20. The flue gas treatment of claim 11, wherein the composition comprises about 45 to about 65 weight % MgO, about 10 to about 30 weight % Al₂O₃ and about 10 to about 30 weight % CuO and CoO, on a dry basis.

21. A flue gas treatment for reducing NOx in the flue of an FCC unit comprising adding a composition in an amount of 0.001 weight % to 1 weight % of the circulating inventory of the total catalyst in the FCC regenerator to the regenerator of the FCC unit; wherein the composition comprises copper and a hydrotalcite like compound containing magnesium and aluminum in a ratio of 2:1 to 5:1; and wherein the regenerator has one or more areas with an oxygen concentration greater than 2% and one or more areas with an oxygen concentration less than 2%.

22. The flue gas treatment of claim 21, wherein the ratio of magnesium to aluminum is 2:1 to 4:1.

23. The flue gas treatment of claim 21, further comprising reducing NOx in the regenerator of the FCC unit.

24. A flue gas treatment for reducing NOx in the flue of an FCC unit comprising adding a composition to the regenerator of the FCC unit; wherein the regenerator has one or more areas with an oxygen concentration greater than 3% and one or more areas with an oxygen concentration less than 2%; wherein the amount of NOx emitted from the regenerator is the same as or greater than the amount of NOx emitted from the regenerator in the absence of the composition; and wherein the composition, on a dry basis, comprises about 45 to about 65 weight % MgO, about 10 to about 30 weight % Al₂O₃ and about 10 to about 30 weight % CuO and/or CoO.

25. The flue gas treatment of claim 24, wherein the composition, on a dry basis, comprises about 50 to about 60 weight % MgO, about 18 to about 28 weight % Al₂O₃ and about 15 to about 25 weight % CuO and/or CoO.

26. A flue gas treatment for reducing CO in the flue of an FCC unit comprising adding a composition comprising copper and/or cobalt and a carrier to the regenerator of the FCC unit.

27. The flue gas treatment of claim 26, further comprising reducing CO emissions from the regenerator of the FCC unit.

28. The method of claim 26, wherein the carrier is a hydrotalcite like compound, a spinel, alumina, zinc titanate, zinc aluminate, or zinc titanate/zinc aluminate.
